(19) United States
(12) Patent Application Publication
(10) Pub. No.: US 2019/0279012 A1
(43) Pub. Date: Sep. 12, 2019

(54) METHODS, SYSTEMS, APPARATUSES AND DEVICES FOR FACILITATING INSPECTION OF INDUSTRIAL INFRASTRUCTURE BY ONE OR MORE INDUSTRY EXPERTS

(71) Applicant: Dusty Birge, Kearney, NE (US)

(72) Inventor: Dusty Birge, Kearney, NE (US)

(21) Appl. No.: 16/351,038

(22) Filed: Mar. 12, 2019

Related U.S. Application Data
(60) Provisional application No. 62/641,552, filed on Mar. 12, 2018.

(51) Int. Cl. G06K 9/03; G06K 9/00; B64C 39/02

(52) U.S. Cl. CPC G06K 9/033; B64C 2201/127; B64C 39/024; G06K 9/00201

(57) ABSTRACT

Disclosed herein is a method of facilitating inspection of industrial infrastructure by one or more industry experts. The method may include receiving, using a communication device, inspection data from at least one monitoring device associated with an industrial infrastructure. Further, the method may include transmitting, using the communication device, the inspection data to a plurality of user devices associated with a plurality of industry experts. Further, the method may include receiving, using the communication device, annotation data corresponding to the inspection data from the plurality of user devices. Further, the method may include storing, using a storage device, the annotation data in association with the inspection data. Further, the method may include analyzing, using a processing device, the annotation data. Further, the method may include generating, using the processing device, an inspection report based on the analyzing. Further, the method may include storing, using the storage device, the inspection report.

### FIELD OF THE INVENTION

Generally, the present disclosure relates to the field of inspection and data processing. More specifically, the present disclosure relates to methods, systems, apparatuses and devices for facilitating inspection of industrial infrastructure by one or more industry experts.

### BACKGROUND OF THE INVENTION

With the demand for products and utilities growing, the amount of industrial infrastructure to facilitate the growing demand has been rapidly increasing. Accordingly, with increase in industrial infrastructure, the need to maintain, service, and repair the growing infrastructure is also increasing.

As such, more methods and systems have been developed to facilitate the inspection, and service of the industrial infrastructure. Further, methods and systems also make use of captured data pertaining to the industrial infrastructure, such as images, videos, sound, captured through various devices, such as cameras, drones, and so on to perform inspection and service of the industrial infrastructure.

Accordingly, existing systems may facilitate the capturing of aerial images of the industrial infrastructure, and the manual review of the captured aerial images to inspect industrial infrastructure, such as aerial cables.

Further, existing systems may include one or more specialized devices, such as aerial vehicles to obtain information relating to a condition of industrial infrastructure and pinpointing areas where damage may have occurred.

However, existing systems may not feature an online platform for facilitating manual review of captured data such as aerial images corresponding to industrial infrastructures, such as electrical distribution systems (e.g. transmission poles etc.) for maintenance purposes by industry experts.

Further, existing systems may not specifically receive inputs, such as rating, notes etc. from industry experts corresponding to the capture data such as aerial images and generating one or more advisories.

Further, existing systems may not include the feature of incorporating the one or more advisories with GIS maps representing the industrial infrastructure.

Further, existing systems may not include the feature of generating one or more inspection reports as a summarization of the one or more advisories that may have been received from industry experts

Therefore, there is a need for improved methods, systems, apparatuses and devices for facilitating inspection of industrial infrastructure by one or more industry experts that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method of facilitating inspection of industrial infrastructure by one or more industry experts. The method may include receiving, using a communication device, inspection data from at least one monitoring device associated with an industrial infrastructure. Further, the method may include transmitting, using the communication device, the inspection data to a plurality of user devices associated with a plurality of industry experts. Further, the method may include receiving, using the communication device, annotation data corresponding to the inspection data from the plurality of user devices. Further, the method may include storing, using a storage device, the annotation data in association with the inspection data. Further, the method may include analyzing, using a processing device, the annotation data. Further, the method may include generating, using the processing device, an inspection report based on the analyzing. Further, the method may include storing, using the storage device, the inspection report.

Further disclosed herein is a system for facilitating inspection of industrial infrastructure by one or more industry experts. The system may include a communication device configured for receiving inspection data from at least one monitoring device associated with an industrial infrastructure. Further, the communication device may be configured for transmitting the inspection data to a plurality of user devices associated with a plurality of industry experts. Further, the communication device may be configured for receiving annotation data corresponding to the inspection data from the plurality of user devices. Further, the system may include a processing device configured for analyzing the annotation data. Further, the processing device may be configured for generating an inspection report based on the analyzing. Further, the system may include a storage device configured for storing the annotation data in association with the inspection data. Further, the storage device may be configured for storing the inspection report.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram representation of a system for facilitating inspection of industrial infrastructure by one or more industry experts, in accordance with some embodiments.

FIG. 3 is a flowchart of a method of facilitating inspection of industrial infrastructure by one or more industry experts, in accordance with some embodiments.

FIG. 4 is a flowchart of a method to facilitate identifying user profiles associated with industry experts, in accordance with further embodiments.

FIG. 5 is a flowchart of a method to facilitate adapting the inspection advisories, in accordance with further embodiments.

FIG. 6 shows a method to facilitate inspection of industrial infrastructure by one or more industry experts, in accordance with some exemplary embodiment.

FIG. 7 is a flowchart of a method to validate correctness of one or more inspection advisories, in accordance with some exemplary embodiment.

FIG. 8 is an exemplary representation of a transmission pole and line with annotation to display one or more faults present in an industrial infrastructure (such as strain on insulators present on a transmission line), in accordance with some embodiments.

FIG. 9 is an exemplary representation of a transmission pole and line with annotation to display one or more faults present in an industrial infrastructure (such as strain on static lines present on a transmission pole), in accordance with some embodiments.

FIG. 10 is an exemplary representation of a transmission pole and line with annotation to display one or more faults present in an industrial infrastructure (such as strain on static lines present on a transmission pole), in accordance with some exemplary embodiment.

FIG. 11 is an exemplary representation of a transmission pole and line with annotation to display one or more faults present in an industrial infrastructure (such as strain on insulators present on a transmission line), in accordance with some exemplary embodiment.

FIG. 12 is an exemplary representation of a transmission pole and line with annotation to display one or more faults present in an industrial infrastructure (such as strain on insulators present on a transmission line), in accordance with some exemplary embodiment.

FIG. 13 is an exemplary inspection report with a pie chart displaying a summary of one or more advisories along with category, in accordance with some embodiments.

FIG. 14 is an exemplary inspection report with a tabular summary of one or more advisories, in accordance with some embodiments.

FIG. 15 is an exemplary representation of a map representing one or more ratings received from one or more inspection advisories, in accordance with some embodiments.

FIG. 16 is an exemplary representation of a map representing specific ratings of the one or more ratings received from one or more inspection advisories, in accordance with some embodiments.

FIG. 17 shows an exemplary page of an inspection interface, in accordance with some embodiments.

FIG. 18 shows an exemplary page of an inspection interface, in accordance with some exemplary embodiment.

FIG. 19 shows an exemplary page of an inspection interface, in accordance with some exemplary embodiment.

FIG. 20 is a block diagram of a computing device for implementing the methods disclosed herein, in accordance with some embodiments.

### DETAILED DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of inspection of industrial infrastructure by one or more industry experts, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps. Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

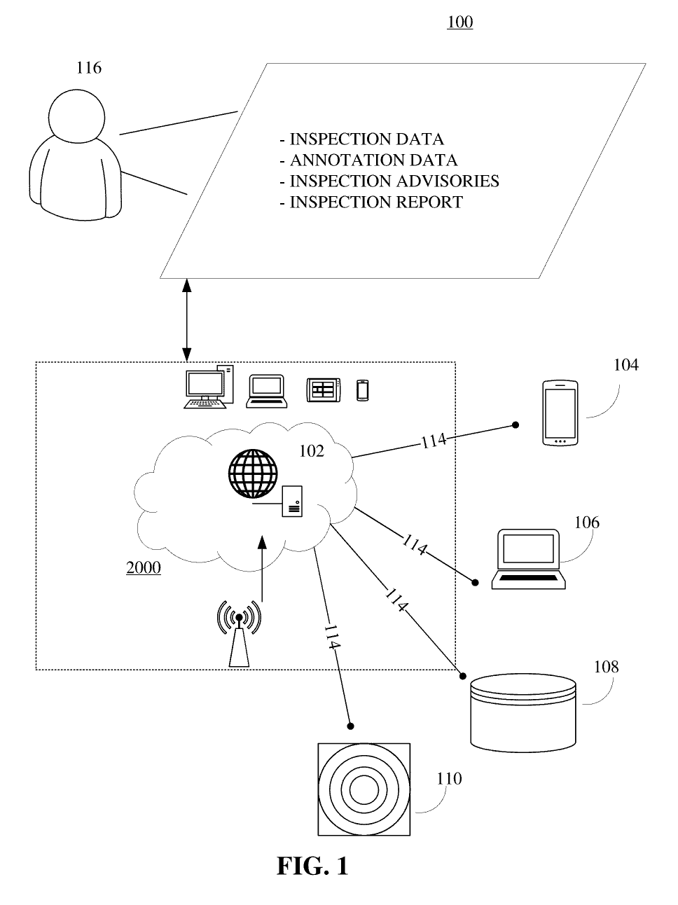

FIG. 1 is an illustration of an online platform 100 consistent with various embodiments of the present disclosure. By way of non-limiting example, the online platform 100 to facilitate inspection of industrial infrastructure by one or more industry experts may be hosted on a centralized server 102, such as, for example, a cloud computing service. The centralized server 102 may communicate with other network entities, such as, for example, a mobile device 104 (such as a smartphone, a laptop, a tablet computer etc.), other electronic devices 106 (such as desktop computers, server computers etc.), databases 108, and sensors 110 over a communication network 114, such as, but not limited to, the Internet. Further, users of the online platform 100 may include relevant parties such as, but not limited to, end users, administrators, service providers, service consumers and so on. Accordingly, in some instances, electronic devices operated by the one or more relevant parties may be in communication with the platform.

A user 116, such as the one or more relevant parties, may access online platform 100 through a web based software application or browser. The web based software application may be embodied as, for example, but not be limited to, a website, a web application, a desktop application, and a mobile application compatible with a computing device 2000. According to some embodiments, the online platform 100 may be provided, to facilitate inspection of industrial infrastructure by one or more industry experts. Industrial infrastructure may include one or more of electrical infrastructure components, such as power poles, transmission lines, solar panels, and wires, mechanical infrastructure components, such as windmills, turbines, and so on. Industry experts may include one or more individual experts with a wide knowledge base pertaining to one or more subjects concerning the industrial infrastructure, and the one or more infrastructural components, related to one or more specific industries.

Further, the online platform 100 may be configured to communicate with one or more user devices. The one or more user devices may include one or more monitoring devices such as cameras, infrared cameras, UV cameras, and one or more mobile user devices with monitoring equipment such as drones and other small Unmanned Aerial Vehicles (SUAVs). Further, the one or more user devices may include mobile devices such as, but not limited to, smartphones, computer tablets, laptops, and so on. The one or more user devices may include a communication device configured to communicate over a communication network such as, but not limited to, a cellular network, a satellite network, a personal area network, Bluetooth, Internet and so on. The one or more user devices may be used to capture data pertaining to the industrial infrastructure, such as images, audio, and videos. Further, the one or more user devices may be used by one or more users of the online platform 100 such as the one or more industry experts to perform inspections of the industrial infrastructure through the captured data pertaining to the industrial infrastructure.

Further, the online platform 100 may allow the one or more industry experts to create user profiles on the online platform 100. The user profiles may contain information such as the name, age, location, etc. of the one or more industry experts. Further, the user profiles may include additional information such as the qualification, educational details, work experience, and technical area of expertise of the one or more industry experts.

Further, the online platform 100 may allow the one or more industry experts to perform an inspection of industrial infrastructure. Industrial infrastructure may include one or more of electrical infrastructure components, such as power poles, transmission lines, solar panels, and wires, mechanical infrastructure components, such as windmills, turbines, and so on. Accordingly, the inspection of the industrial infrastructure may be performed by one or more industry experts with a wide knowledge base pertaining to one or more subjects concerning the industrial infrastructure, and the one or more infrastructural components, related to one or more specific industries. The online platform 100 may facilitate the performance of the inspection by providing an inspection interface. The inspection interface may be a user interface that may be accessed by the one or more industry experts through one or more user devices. Accordingly, upon the performance of inspection through the inspection interface, the one or more industry experts may provide one or more inspection advisories. The one or more inspection advisories may include details about one or more components of the industrial infrastructure, one or more faults that may be present in the one or more components of the industrial infrastructure, and the degree of the one or more faults present in the one or more components of the industrial infrastructure.

Further, the online platform 100 may generate an inspection report. The inspection report may be generated after the inspection of industrial infrastructure may have been performed by one or more industry experts. The inspection report may include a summary of one or more inspection advisories provided by one or more industry experts. The inspection report may be generated by after receiving the one or more inspection advisories from one or more industry experts. Accordingly, the one or more inspection advisories may be combined and analyzed to generate the inspection report. The one or more inspection advisories may be chosen to be combined and analyzed into one inspection report on the basis of one or more factors, such as location, area, type of industry, and so on. For instance, one or more inspection advisories, relating to the industrial infrastructure of one particular industry that may be located in a particular location or region may be combined and analyzed. Accordingly, an inspection report may be generated.

Further, the online platform 100 may automatically annotate the received inspection data. The annotation of the inspection data may describe, and prominently display one or more faults present in industrial infrastructure. In an instance, the online platform 100 may automatically annotate the one or more one or more images present in inspection data to describe, and prominently display one or more faults present in industrial infrastructure. The online platform 100 may automatically assign metadata in the form of captioning or keywords to the one or more images present in the inspection data. The one or more annotations may be provided upon the analysis of the one or more images, and performance of object recognition to recognize and determine one or more faults present in the industrial infrastructure.

Further, the online platform 100 may link the one or more advisories received from one or more industry experts with one or more GIS maps representing the one or more components of the industrial infrastructure. The online platform 100 may integrate the one or more advisories received from the one or more industry experts with one or more GIS maps representing the industrial infrastructure, including the information received in the one or more advisories with the one or more attributes represented in the GIS map of the industrial infrastructure, and the one or more components of the industrial infrastructure.

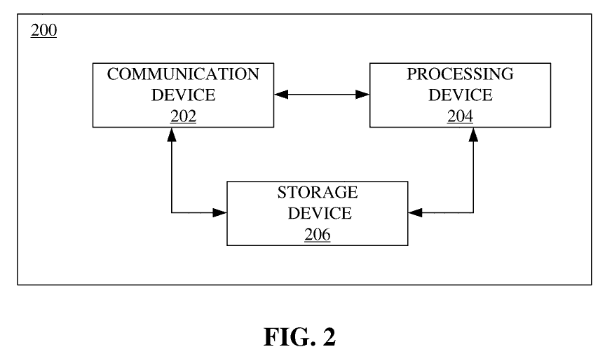

FIG. 2 is a block diagram representation of a system 200 for facilitating inspection of industrial infrastructure by one or more industry experts, in accordance with some embodiments. Accordingly, the system 200 may include a communication device 202 configured for receiving inspection data from at least one monitoring device associated with an industrial infrastructure. Further, the industrial infrastructure, in an instance, may be any infrastructure which may need to be inspected by the one or more industry experts. Further, in some embodiments, the industrial infrastructure may include electrical infrastructure. For instance, the industrial infrastructure may include one or more of electrical infrastructure components, such as (but not limited to) power poles, transmission lines, solar panels, and wires, mechanical infrastructure components, such as (but not limited to) windmills, turbines, and so on. Further, the inspection data, in an instance, may be any data associated with the industrial infrastructure that may be analyzed by the one or more industry expert to facilitate inspection. Further, in some embodiments, the inspection data may include one or more of audio, image and video. For instance, the inspection data received from the at least one monitoring device may be in the form of images, audio, infrared images, UV images, and so on. Further, the at least one monitoring device, in an instance, may be any device that may be configured to capture any physical, chemical and/or biological variable associated with the industrial infrastructure in order to monitor the industrial infrastructure. Further, in some embodiments, the at least one monitoring device may include a drone configured for sensing the inspection data. For instance, the drone may include components such as, but not limited to, a camera, a microphone and one or more sensors configured to capture physical, chemical and/or biological variables.

Further, the communication device 202 may be configured for transmitting the inspection data to a plurality of user devices associated with a plurality of industry experts. Accordingly, the plurality of industry expert, in an instance, may be one or more individual experts with a wide knowledge base pertaining to one or more subjects concerning the industrial infrastructure, and the one or more infrastructural components, related to one or more specific industries. Further, the plurality of user devices, in an instance, may be devices that may be operated by the plurality of industry experts to perform an inspection of the industrial infrastructure through the inspection data pertaining to the industrial infrastructure. Further, the plurality of user devices, in an instance, may include IoT based devices (that may be configured to communicate with the online platform 100) such as, but not limited to, smartphones, smartwatches, computer tablets, laptops, and so on. Further, the plurality of user devices may include a communication device configured to communicate over a communication network such as, but not limited to, a cellular network, a satellite network, a personal area network, Bluetooth, Internet and so on.

Further, the communication device 202 may be configured for receiving annotation data corresponding to the inspection data from the plurality of user devices. Accordingly, the annotation data, in an instance, may be any information and/or data that may be provided by the plurality of industry experts (through the plurality of user devices) as a response to the inspection data associated with the industrial infrastructure. In some embodiments, the receiving of the annotation data may include receiving annotated inspection data including the inspection data and the annotation data.

Further, the system 200 may include a processing device 204 configured for analyzing the annotation data. Further, the analyzing of the annotation data, in an instance, may include processes such as, but not limited to, data extraction (e.g. numerical value extraction, format conversion etc.), data analysis (e.g. statistical analysis etc.), image analysis (e.g. OCR, object recognition, face recognition etc.), audio analysis (e.g. speech recognition, speaker recognition etc.) and so on.

Further, the processing device 204 may be configured for generating an inspection report based on the analyzing. Accordingly, the inspection report, in an instance, may be a summarized report that may be generated based on the analyzing. Further, the inspection report, in an instance, may provide information that may be of something of interest to the user with regard to the inspection of the industrial infrastructure. For instance, the inspection report may include visual data (such as a graph and/or a chart) which may reflect a severity of fault for different components of the industrial infrastructure. Further, in some embodiments, the generating of the inspection report may be based on analyzing of the inspection data corresponding to the annotation data.

Further, the system 200 may include a storage device 206 configured for storing the annotation data in association with the inspection data.

Further, the storage device 206 may be configured for storing the inspection report. In further embodiments, the processing device 204 may be configured for analyzing the inspection data. Further, the processing device 204 may be configured for determining the plurality of user devices based on the analyzing of the inspection data and a plurality of user profiles. Further, the plurality of user profiles, in an instance, may be profiles associated with the plurality of industry experts, which may contain information such as (but not limited to) name, age, location, etc. of the plurality of industry experts. Further, the plurality of user profiles may include additional information such as (but not limited to) qualification, educational details, work experience, and/or technical area of expertise of the plurality of industry experts. Further, the storage device 206 may be configured for retrieving the plurality of user profiles associated with the plurality of industry experts. Further, in some embodiments, the analyzing of the inspection data may include performing object recognition of at least one object associated with the industrial infrastructure as represented in the inspection data. For instance, the processing device 204 may be configured to identify electrical components (such as insulators, static lines, transmission poles etc.) associated with the industrial infrastructure by performing object recognition on the inspection data (such as an image) captured by a camera embedded within the at least one monitoring device (e.g. the drone).

In further embodiments, the annotation data may include inspection advisories. Accordingly, the inspection advisories may include details about one or more components of the industrial infrastructure, one or more faults that may be present in one or more components of the industrial infrastructure, and/or the degree of the one or more faults present in the one or more components of the industrial infrastructure. In some embodiments, the processing device 204 may be further configured for analyzing the inspection data and the inspection advisories. Further, the processing device 204 may be configured for identifying at least one discrepancy associated with the inspection advisories based on the analyzing of the inspection data and the inspection advisories. Further, the processing device 204 may be configured for modifying the inspection advisories based on the identifying of the at least one discrepancy. Further, in some embodiments, the analyzing of the inspection data and the inspection advisories may include determining at least one characteristic of at least one object associated with the industrial infrastructure as represented in the inspection data. Further, the analyzing of the inspection data and the inspection advisories may include comparing the at least one characteristic with the inspection advisories corresponding to the at least one object. Further, the identifying of the at least one discrepancy may be based on the comparing.

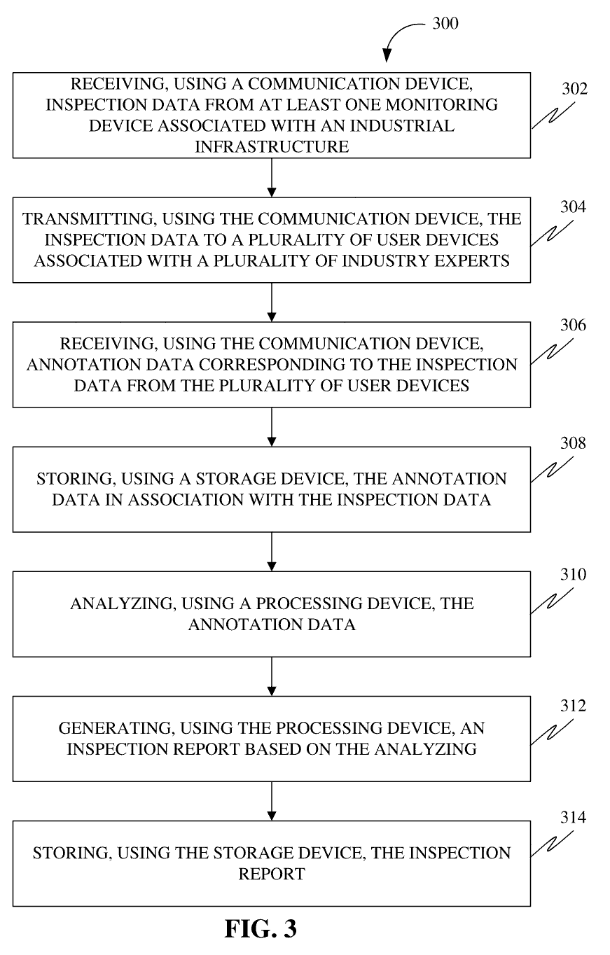

FIG. 3 is a flowchart of a method 300 of facilitating inspection of industrial infrastructure by one or more industry experts, in accordance with some embodiments. Accordingly, at 302, the method 300 may include receiving, using a communication device (such as the communication device 202), inspection data from at least one monitoring device associated with an industrial infrastructure. In some embodiments, the industrial infrastructure may include electrical infrastructure. Further, in some embodiments, the at least one monitoring device may include a drone configured for sensing the inspection data. Further, in some embodiments, the inspection data may include one or more of audio, image and video.

Further, at 304, the method 300 may include transmitting, using the communication device, the inspection data to a plurality of user devices associated with a plurality of industry experts.

Further, at 306, the method 300 may include receiving, using the communication device, annotation data corresponding to the inspection data from the plurality of user devices. In some embodiments, the receiving of the annotation data may include receiving annotated inspection data including the inspection data and the annotation data.

Further, at 308, the method 300 may include storing, using a storage device (such as the storage device 206), the annotation data in association with the inspection data.

Further, at 310, the method 300 may include analyzing, using a processing device (such as the processing device 204), the annotation data.

Further, at 312, the method 300 may include generating, using the processing device, an inspection report based on the analyzing. In some embodiments, the generating of the inspection report may be based further on analyzing of the inspection data corresponding to the annotation data.

Further, at 314, the method 300 may include storing, using the storage device, the inspection report.

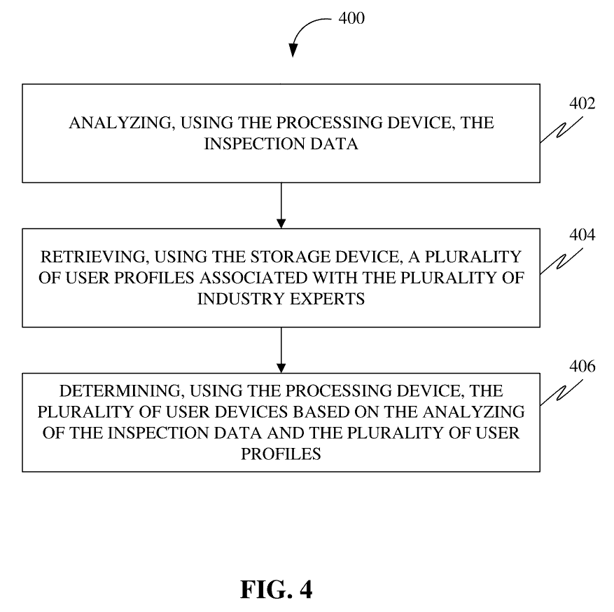

FIG. 4 is a flowchart of a method 400 to facilitate identifying user profiles associated with industry experts, in accordance with further embodiments. Accordingly, at 402, the method 400 may include analyzing, using the processing device, the inspection data. In some embodiments, the analyzing of the inspection data may include performing object recognition of at least one object associated with the industrial infrastructure as represented in the inspection data.

Further, at 404, the method 400 may include retrieving, using the storage device, a plurality of user profiles associated with the plurality of industry experts.

Further, at 406, the method 400 may include determining, using the processing device, the plurality of user devices based on the analyzing of the inspection data and the plurality of user profiles.

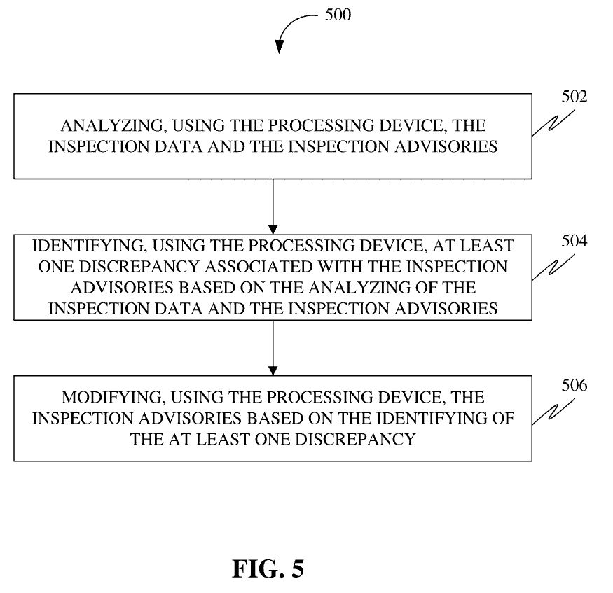

In further embodiments, the annotation data may include inspection advisories. FIG. 5 is a flowchart of a method 500 to facilitate adapting the inspection advisories, in accordance with further embodiments. Accordingly, at 502, the method 500 may include analyzing, using the processing device, the inspection data and the inspection advisories.

Further, at 504, the method 500 may include identifying, using the processing device, at least one discrepancy associated with the inspection advisories based on the analyzing of the inspection data and the inspection advisories.

Further, at 506, the method 500 may include modifying, using the processing device, the inspection advisories based on the identifying of the at least one discrepancy. Further, in some embodiments, the analyzing of the inspection data and the inspection advisories may include determining at least one characteristic of at least one object associated with the industrial infrastructure as represented in the inspection data. Further, the analyzing of the inspection data and the inspection advisories may include comparing the at least one characteristic with the inspection advisories corresponding to the at least one object. Further, the identifying of the at least one discrepancy may be based on the comparing.

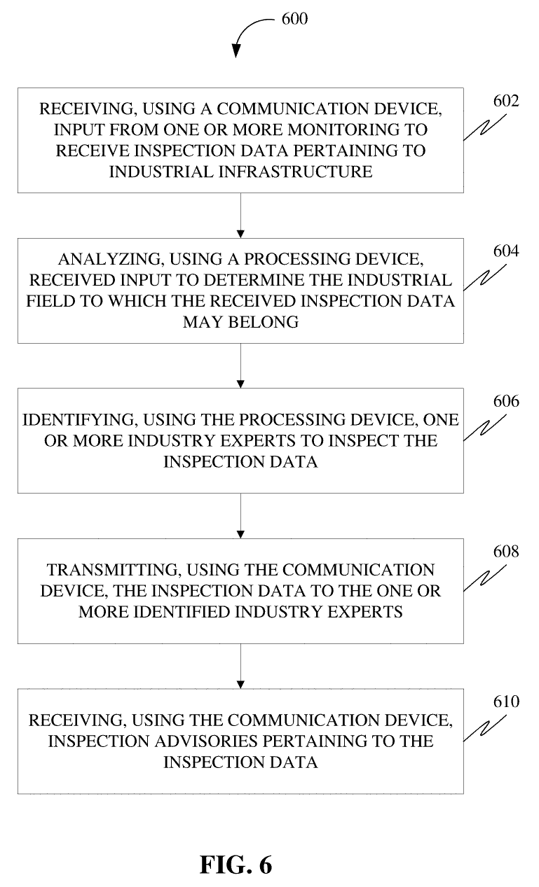

FIG. 6 shows a method 600 to facilitate inspection of industrial infrastructure by one or more industry experts, in accordance with some exemplary embodiment. Accordingly, at 602, the method 600 may include a step of receiving, using a communication device (such as the communication device 202), input from one or more monitoring devices to receive inspection data pertaining to industrial infrastructure. Further, the input may be received from one or more user devices. Further, the one or more monitoring devices may include one or more devices such as cameras, infrared cameras, UV cameras, and one or more mobile user devices with monitoring equipment such as drones and other Small Unmanned Aerial Vehicles (SUAVs). Further, the one or more monitoring devices may include a communication device configured to communicate over a communication network such as, but not limited to, a cellular network, a satellite network, a personal area network, Bluetooth, Internet and so on. Accordingly, the inspection data received may be in the form of images, audio, infrared images, UV images, and so on. In an instance, the inspection data may be received through an input mechanism of the one or more monitoring devices. Further, the one or more monitoring devices may be configured to communicate with the communication device of a server computer. Accordingly, in an instance, the inspection data input through the input mechanism may be transmitted from the one or more monitoring devices to the server computer. In some embodiments, the inspection data may be automatically retrieved from the one or more monitoring devices and/or transmitted to the server computer.

Further, at 604, the method 600 may include a step of analyzing, using a processing device (such as the processing device 204), the received input to determine the industrial field or domain to which the received inspection data may belong. In an instance, a metadata of the received inspection data, such as (but not limited to) file name, one or more tags in the one or more files of the inspection data, and so on may be analyzed to determine the industrial field or domain to which the received inspection data may belong. Further, in an embodiment, the metadata may not provide sufficient information about the industrial field or domain, and the received inspection data may be analyzed to determine an industrial field or domain. For instance, if the received inspection data includes one or more images, the one or more images may be analyzed, and object recognition may be performed to determine one or more objects, industrial components, and thus determine the industrial field or domain to which the received inspection data may belong.

Further, at 606, the method 600 may include a step of identifying, using the processing device, one or more industry experts to inspect the inspection data. Further, the one or more industry experts may be identified based on the industrial field or domain to which the inspection data may belong, and the area of expertise of the one or more industry experts. Accordingly, based on the industrial field or domain to which the inspection data may belong, the user profile data of the one or more industry experts may be analyzed. For instance, user profile data such as the qualification, educational details, work experience, and technical area of expertise of the one or more industry experts may be analyzed. Accordingly, one or more matches may be found between the industrial field and/or domain to which the inspection data may belong and the user profile data of the one or more industry experts, and one or more industry experts may be identified.

Further, at 608, the method 600 may include a step of transmitting, using the communication device, the inspection data to the one or more identified industry experts, wherein, the one or more industry experts may perform the inspection of the inspection data through the inspection interface. Further, the inspection data may be transmitted to one or more user devices, such as, but not limited to, smartphones, computer tablets, laptops, and so on, of the one or more identified industry experts. Accordingly, the one or more industry experts may proceed to perform the analysis of the inspection data, and therefore of the industrial infrastructure. The one or more industry experts may analyze the inspection data pertaining to the industrial infrastructure and determine one or more faults that may be present in the industrial infrastructure. Accordingly, the one or more industry experts may make use of the inspection interface, and provide one or more advisories detailing the one or more faults, and one or more corrective measures that may be needed to rectify the one or more faults.

Further, at 610 the method 600 may include a step of receiving, using the communication device, one or more inspection advisories pertaining to the inspection data. In an instance, the one or more inspection advisories may be received through an input mechanism of the one or more user devices of the one or more industry experts. Further, the one or more user devices of the one or more industry experts may be configured to communicate with the communication device of a server computer. Accordingly, in an instance, the one or more inspection advisories input through the input mechanism may be transmitted from the one or more user devices of the one or more industry experts to the server computer. In some embodiments, the one or more inspection advisories may be automatically retrieved from the one or more user devices of the one or more industry experts and/or transmitted to the server computer.

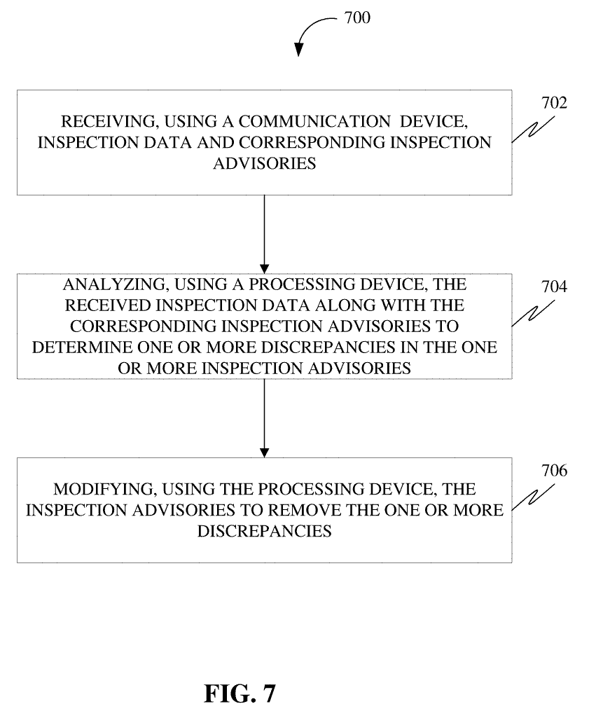

FIG. 7 is a flowchart of a method 700 to validate the correctness of the one or more inspection advisories, in accordance with some exemplary embodiment. Accordingly, at 702, the method 700 may include a step of receiving, using a communication device (such as the communication device 202), inspection data and corresponding inspection advisories. Further, the inspection data may be received from one or more monitoring devices such as cameras, infrared cameras, UV cameras, and one or more mobile user devices with monitoring equipment such as drones and other Small Unmanned Aerial Vehicles (SUAVs). The one or more monitoring devices may include a communication device configured to communicate over a communication network such as, but not limited to, a cellular network, a satellite network, a personal area network, Bluetooth, Internet and so on. Accordingly, the inspection data received may be in the form of images, audio, infrared images, UV images, and so on. In an instance, the inspection data may be received through an input mechanism of the one or more monitoring devices. Further, the one or more monitoring devices may be configured to communicate with the communication device of a server computer. Accordingly, in an instance, the inspection data input through the input mechanism may be transmitted from the one or more monitoring devices to the server computer. In some embodiments, the inspection data may be automatically retrieved from the one or more monitoring devices device and/or transmitted to the server computer. Further, corresponding one or more inspection advisories pertaining to the inspection data may be received through an input mechanism of the one or more user devices of one or more industry experts. Further, the one or more user devices of the one or more industry experts may be configured to communicate with the communication device of a server computer. Accordingly, in an instance, the one or more inspection advisories input through the input mechanism may be transmitted from the one or more user devices of the one or more industry experts to the server computer. In some embodiments, the one or more inspection advisories may be automatically retrieved from the one or more user devices of the one or more industry experts and/or transmitted to the server computer.

Further, at 704, the method 700 may include a step of analyzing, using a processing device (such as the processing device 204), the received inspection data along with the corresponding inspection advisories to determine one or more discrepancies in the one or more inspection advisories. The analysis may include analyzing the inspection advisories and determining one or more faults that may have been present in the industrial infrastructure. Accordingly, the corresponding inspection data, such as images may be analyzed. For instance, if the inspection data includes one or more images, the one or more images may be analyzed, and object recognition may be performed on the one or more images. Accordingly, the one or more images may be analyzed to determine and validate whether the one or more faults described in the one or more inspection advisories may be visible or evident in the one or more images. Further, the one or more images may be analyzed to determine whether any other fault that may not have been described in the one or more inspection advisories may be visible or evident in the one or more images. Further, the inspection data and the one or more inspection advisories may be analyzed to determine consistency in the one or more inspection advisories. For instance, if one or more components of the industrial infrastructure, as captured in the inspection data, have been rated on a scale of A to E (A describing that the industrial infrastructure may be in perfect operational condition, and E describing that the industrial infrastructure may need to be immediately replaced), the corresponding inspection data, such as one or more images, may be analyzed to determine the validity and the consistency of the one or more ratings provided to the industrial infrastructure. For e.g., if one or more components of the industrial infrastructure, as captured in the inspection data, may have been rated as A on a scale of A to E, the corresponding images may be analyzed to determine whether any faults in the industrial infrastructure may be visible or evident in the one or more images. Accordingly, if one or more faults are visible or evident in the one or more corresponding images present in the inspection data, the ratings, and subsequently, the one or more advisories may be determined to be inconsistent with the inspection data. Further, at 706, the method 700 may include a step of modifying, using the processing device, the inspection advisories to remove the one or more discrepancies. Accordingly, if the one or more inspection advisories are incomplete, and do not include one or more additional faults, the one or more additional faults may be added in the one or more inspection advisories. Further, if the one or more inspection advisories are determined to be inconsistent, the one or more inspection advisories may be modified so as to maintain consistency with the inspection data. For instance, if one or more components of the industrial infrastructure, as captured in the inspection data, are rated as A on a scale of A to E, and if one or more faults are visible in the one or more corresponding images present in the inspection data, the ratings, and subsequently, the one or more advisories may be determined to be inconsistent with the inspection data, and may be modified to reflect the one or more faults visible in the one or more corresponding images.

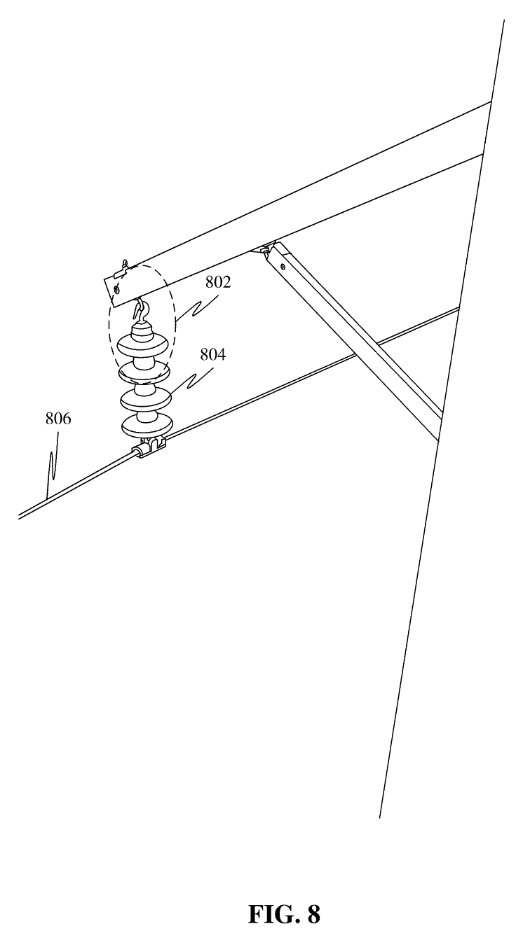

FIG. 8 is an exemplary representation of a transmission pole and line with annotation to display one or more faults present in the industrial infrastructure (such as strain on insulators present on the transmission line), in accordance with some embodiments.

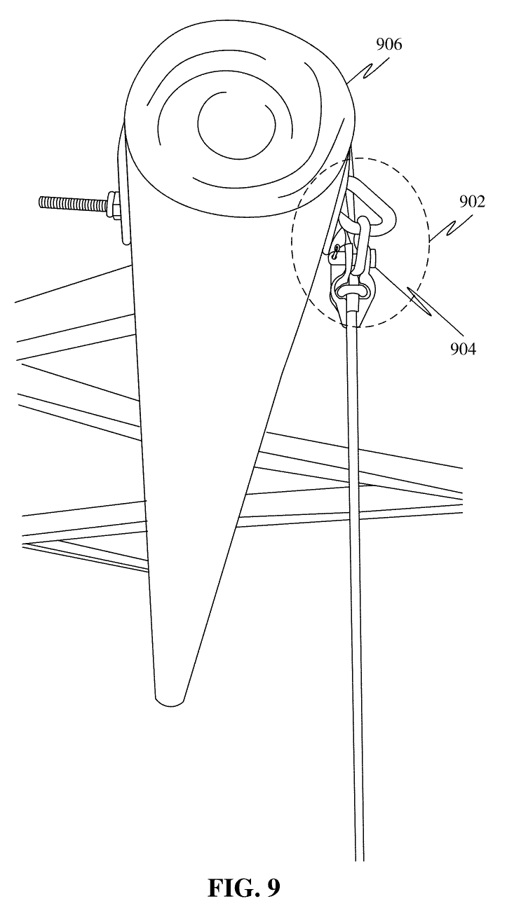

Further, FIG. 9 is an exemplary representation of a transmission pole and line with annotation to display one or more faults present in the industrial infrastructure (such as strain on static lines present on the transmission poles), in accordance with some embodiments.

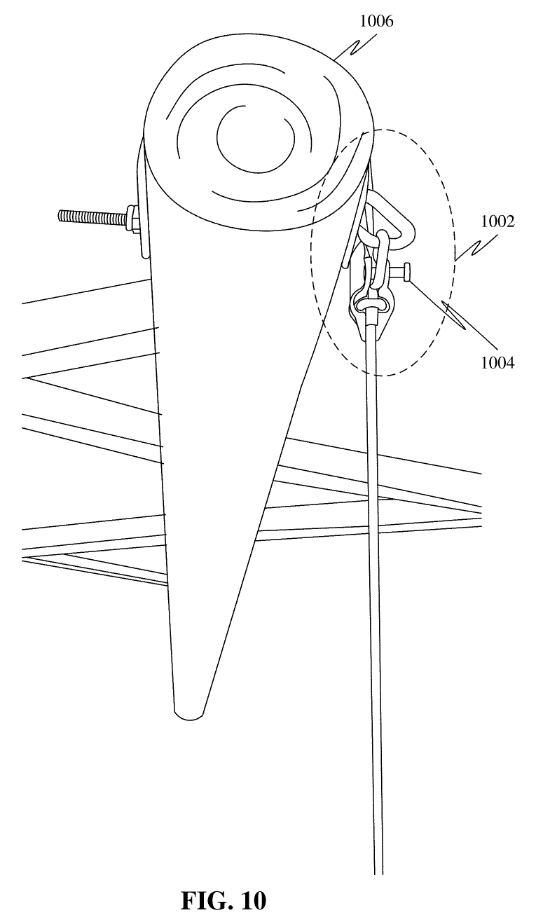

Further, FIG. 10 is an exemplary representation of a transmission pole and line with annotation to display one or more faults present in the industrial infrastructure (such as strain on static lines present on the transmission poles), in accordance with some exemplary embodiments.

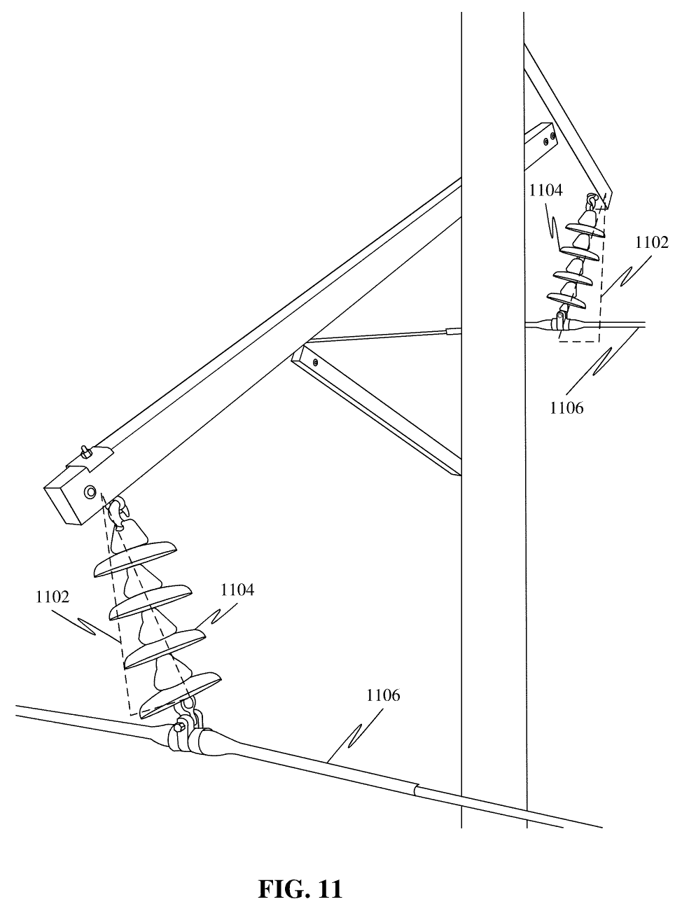

Further, FIG. 11 is an exemplary representation of a transmission pole and line with annotation to display one or more faults present in the industrial infrastructure (such as strain on insulators present on the transmission line), in accordance with some exemplary embodiment.

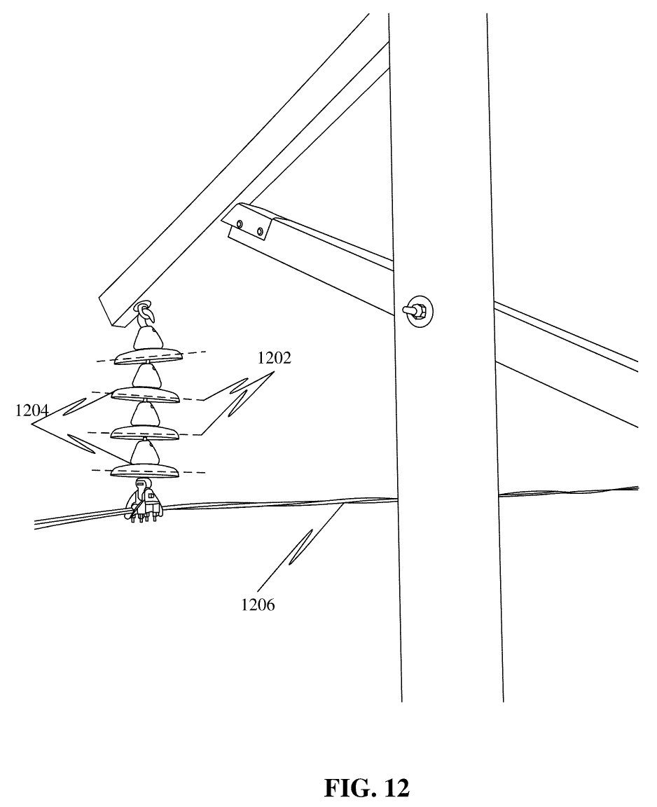

Further, FIG. 12 is an exemplary representation of a transmission pole and line with annotation to display one or more faults present in the industrial infrastructure (such as strain on insulators present on the transmission line), in accordance with some exemplary embodiment.

FIG. 8, FIG. 9, FIG. 10, FIG. 11, and FIG. 12 show an exemplary embodiment of the system to facilitate inspection of industrial infrastructure by one or more industry experts. Accordingly, the figures show automatic annotation of one or more images present in inspection data to describe and prominently display one or more faults present in industrial infrastructure. In an embodiment, the online platform 100 may automatically annotate the one or more images present in inspection data to describe and prominently display one or more faults present in industrial infrastructure. The online platform 100 may automatically assign metadata in the form of captioning or keywords to the one or more images present in the inspection data. Further, the one or more annotations may be provided upon analysis of the one or more images, and performance of object recognition to recognize, and determine one or more faults present in the industrial infrastructure. For instance, if the industrial infrastructure is electrical (for e.g. transmission line, poles, transformers, etc.), and the inspection data includes one or more images of the industrial infrastructure, the one or more images may be annotated to illustrate one or more faults in the industrial infrastructure. For example, as shown in FIG. 8, FIG. 11, and FIG. 12, one or more images of transmission lines (such as transmission line 806, 1106, and 1206), as included in the inspection data, are annotated (such as annotation 802, 1102, and 1202) to display faults such as strain on the insulators 804, 1104, and 1204 present on the transmission lines 806, 1106, and 1206 respectively. Further, as shown in FIG. 9, and FIG. 10, one or more images of transmission poles and lines, as included in the inspection data, are annotated (such as annotation 902, and 1002) to display faults such as strain on the static lines 904 and 1004 present on the transmission poles 906 and 1006 respectively.

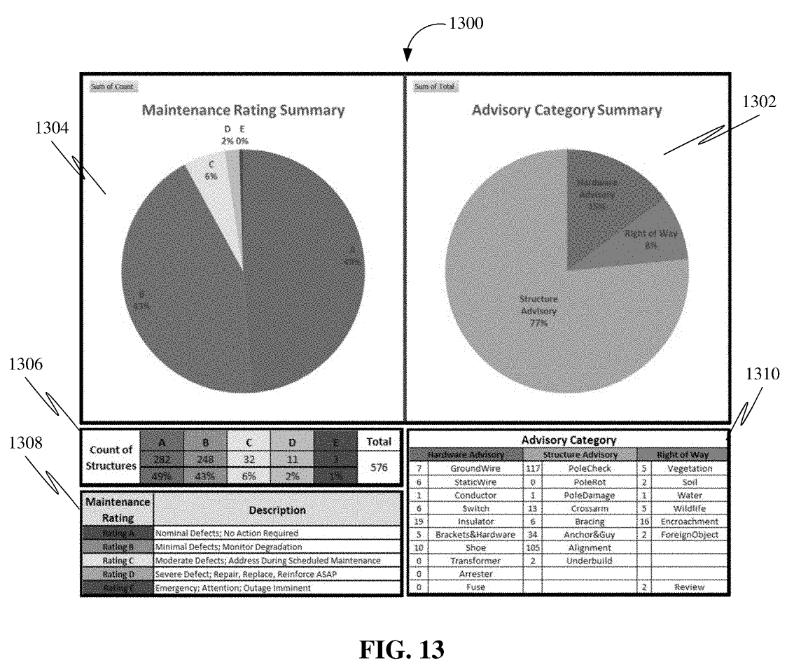

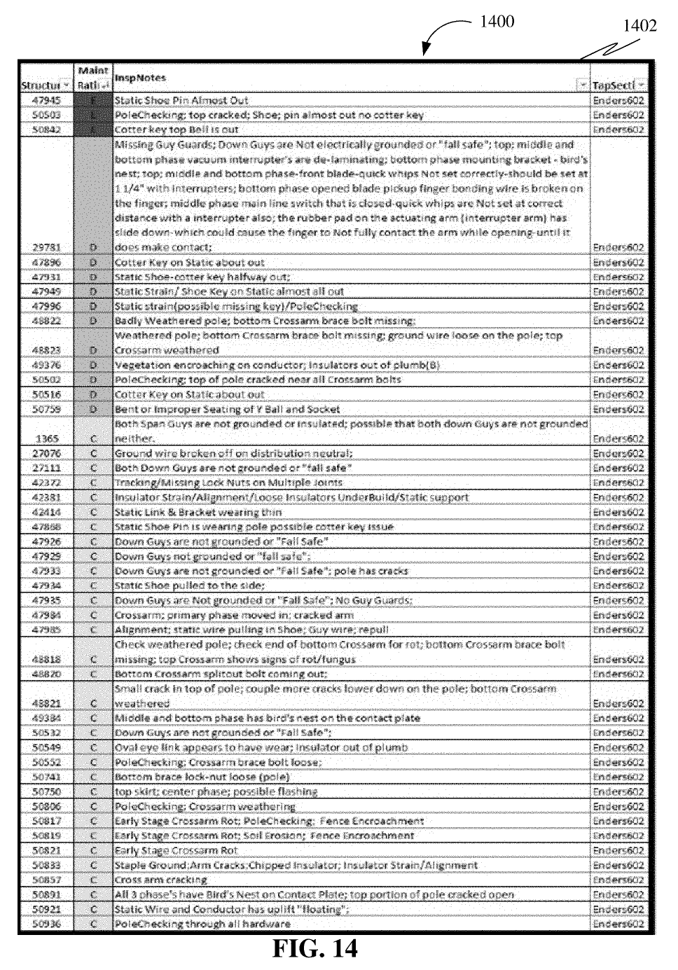

FIG. 13 is an exemplary inspection report with a pie chart displaying a summary of the one or more advisories along with category, in accordance with some embodiments. Further, FIG. 14 is an exemplary inspection report with a tabular summary of the one or more advisories, in accordance with some exemplary embodiments.

FIG. 13 and FIG. 14 show an exemplary embodiment of the system to facilitate inspection of industrial infrastructure by one or more industry experts, showing an exemplary inspection report (such as the inspection report 1300 or the inspection report 1400) displaying a summary of one or more advisories provided by one or more industry experts. The inspection report may be generated by the online platform 100 after receiving one or more inspection advisories from one or more industry experts. Accordingly, the one or more inspection advisories may be combined and analyzed to generate the inspection report. The one or more inspection advisories may be chosen to be combined and analyzed into one inspection report on the basis of one or more factors, such as location, area, type of industry, and so on. For instance, one or more inspection advisories, relating to the industrial infrastructure of one particular industry that may be located in a particular location or region may be combined and analyzed. Accordingly, an inspection report (such as the inspection report 1300 or the inspection report 1400) may be generated. For instance, as shown in FIG. 13, the inspection report 1300 may include one or more graphs and/or charts (such as an advisory-category pie chart 1302 and a maintenance-rating pie chart 1304) describing the one or more advisories and showing numerical proportions of the one or more types of advisories. For instance, if the one or more advisories contain one or more ratings (such as maintenance ratings on a scale from A to E as described in a rating table 1308) provided to the one or more industrial components, a pie chart (such as the maintenance-rating pie chart 1304) displaying the breakdown of a number of component (such as number of components described in a component table 1306), along with the ratings may be generated. Further, as shown in FIG. 13, a pie chart (such as the advisory-category pie chart 1302) displaying a summary of the one or more advisories along with category (such as hardware advisory, structure, and so on, as described in an Advisory-category table 1310) may be generated. Further, as shown in FIG. 14, the inspection report 1400 may include a tabular summary 1402 of the one or more advisories, containing possible ratings, information about the one or more industrial components and structures, such as a reference id, and details about the one or more advisories.

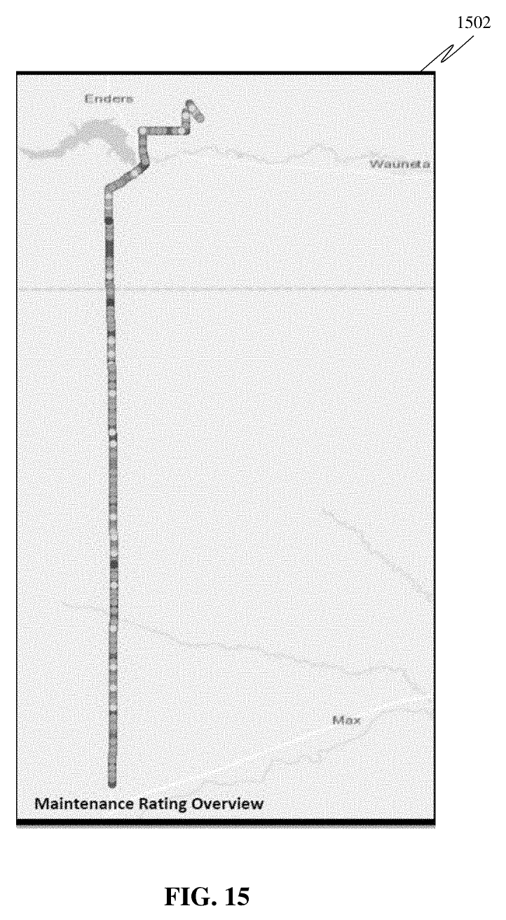

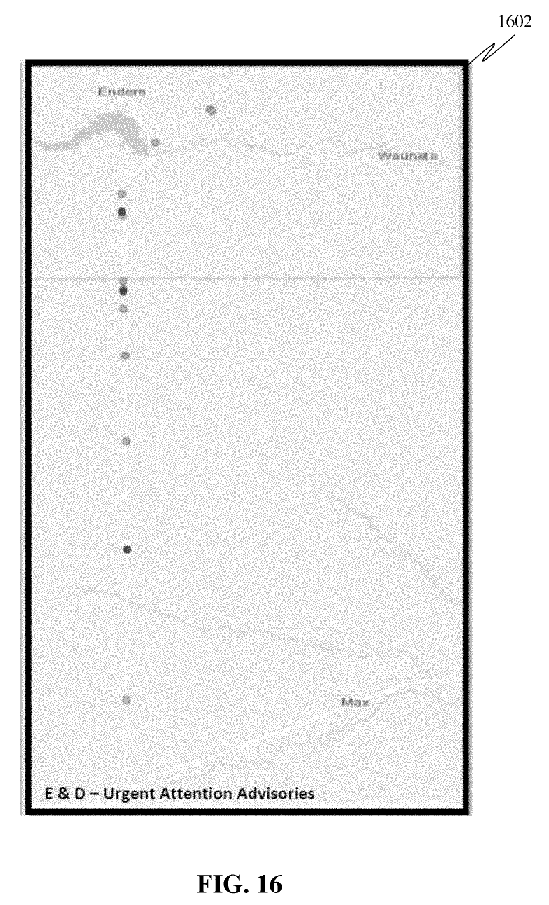

FIG. 15 is an exemplary representation of a map showing one or more ratings received from the one or more inspection advisories, in accordance with some embodiments. Further, FIG. 16 is an exemplary representation of a map showing specific ratings of the one or more ratings received from the one or more inspection advisories, in accordance with some embodiments.

FIG. 15 and FIG. 16 show an exemplary embodiment of the system to facilitate inspection of industrial infrastructure by one or more industry experts, showing linking of the one or more advisories received from one or more industry experts with a GIS map (such as a map 1502 or map 1602) representing the one or more components of the industrial infrastructure. The online platform 100 may integrate the one or more advisories received from the one or more industry experts with one or more GIS maps representing the industrial infrastructure, including the information received in the one or more advisories with the one or more attributes represented in the GIS map of the industrial infrastructure, and the one or more components of the industrial infrastructure. For instance, a GIS map may include spatial information about one or more industrial components, along with other attributes including details of the one or more industrial components and structures, such as type, name, and purpose of industrial components and structures, along with any other one or more technical specifications. Accordingly, after integration of the information received in the one or more advisories in the attributes of the one or more industrial components and structures, the GIS map may be modified. For instance, as shown in FIG. 15, the GIS map (such as the map 1502) representing the industrial infrastructure may be modified to represent one or more ratings received in the one or more inspection advisories. Further, the information received in the one or more advisories may be used to toggle and set filters to display the specific industrial components and structures. For instance, as shown in FIG. 16, specific ratings (e.g. structures rated D and E, as described in the rating table 1308 of FIG. 13) received in the one or more inspection advisories may be used to toggle and set filters to display the specific industrial components and structures in the GIS map (such as the map 1602), such displaying industrial components and structures rated D and E.

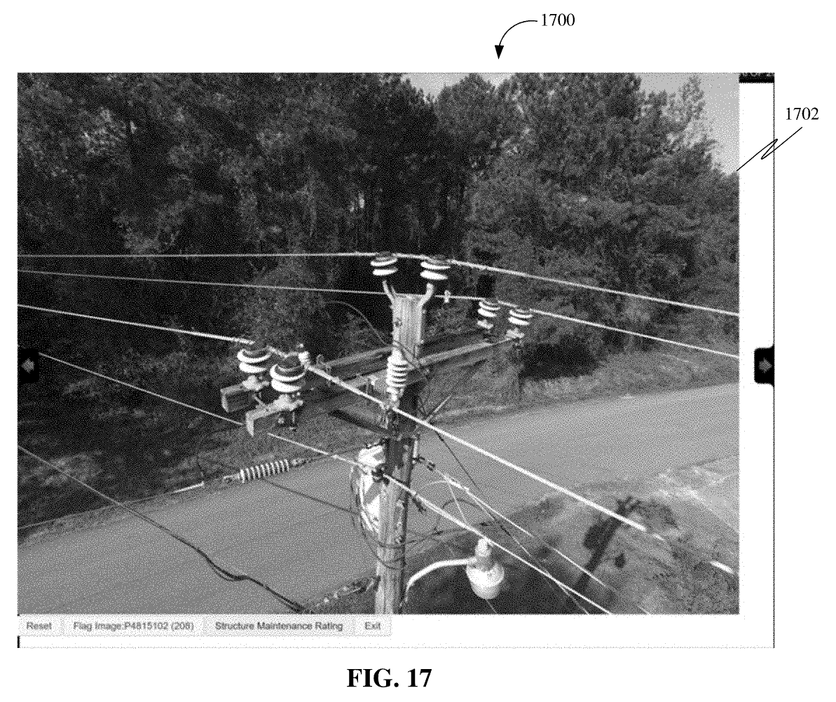

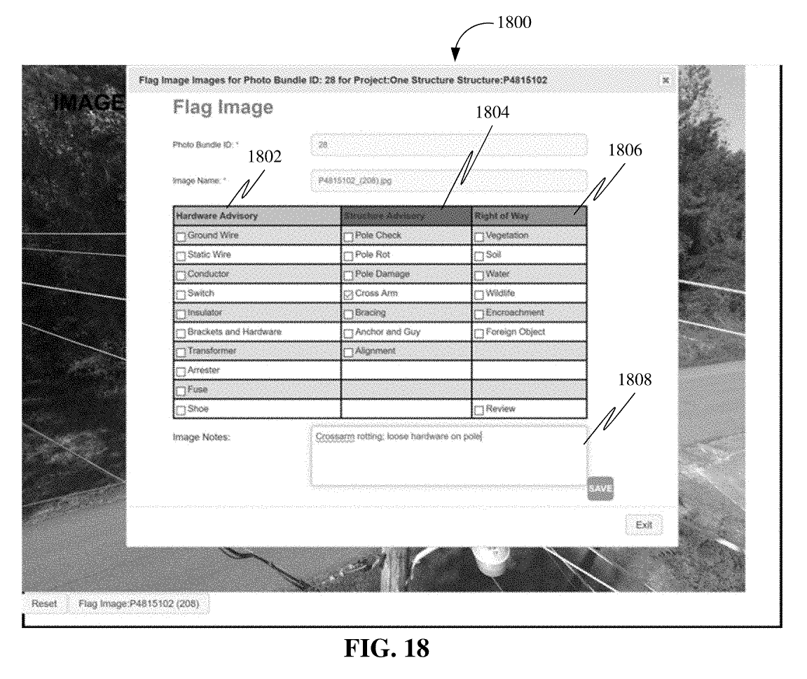

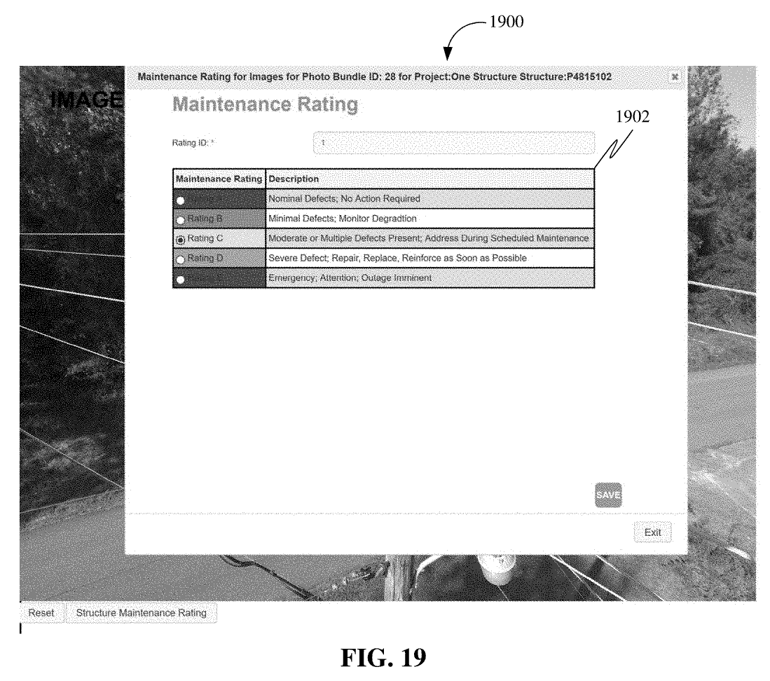

FIG. 17 is an exemplary page of the inspection interface, in accordance with some embodiments. Further, FIG. 18 is an exemplary page of the inspection interface, in accordance with an exemplary embodiment. Further, FIG. 19 is an exemplary page of the inspection interface, in accordance with an exemplary embodiment.

FIG. 17, FIG. 18, and FIG. 19 show an exemplary embodiment of the system to facilitate inspection of industrial infrastructure by one or more industry experts, showing inspection interfaces (such as an inspection interface 1700, 1800, and 1900) that may be used by one or more industry experts to inspect inspection data, and provide one or more inspection advisories. Accordingly, FIG. 17 shows an exemplary page of the inspection interface 1700, showing exemplary inspection data (such as an image 1702) that may be viewed by the one or more industry experts to perform the inspection. Accordingly, the one or more industry experts may perform an inspection of the industrial infrastructure through the data provided.

Further, FIG. 18 shows an exemplary page of the inspection interface 1800 that may allow the one or more industry experts to provide one or more inspection advisories, such as hardware advisories 1802 (e.g. ground wire, static wire, conductor, switch, etc.), structure advisories 1804 (e.g. pole check, pole rot, cross arm, etc.), and right of way advisories 1806 (e.g. vegetation, soil, water, etc.). Further, the inspection interface 1800 may allow the one or more industry experts to provide notes, and details about the one or more advisories (through a note section 1808).

Further, FIG. 19 shows an exemplary page of the inspection interface 1900 that may allow the one or more industry experts to provide one or more ratings to the industrial infrastructure through a rating section 1902. In an instance, the one or more industry experts may provide ratings on a scale of A to E (A describing that the industrial infrastructure may be in perfect operational condition, and E describing that the industrial infrastructure may need to be immediately replaced).

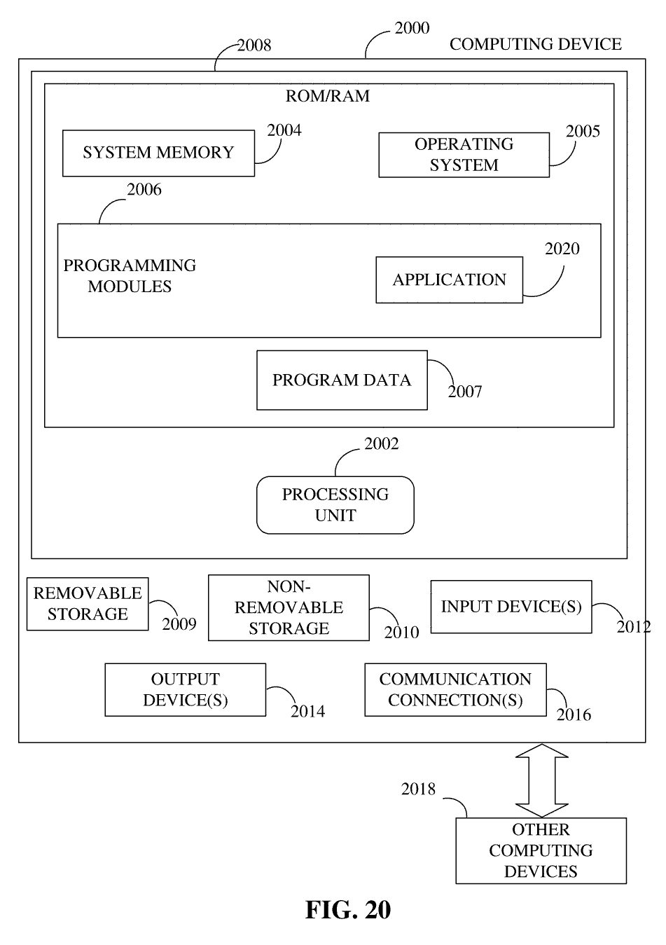

With reference to FIG. 20, a system consistent with an embodiment of the disclosure may include a computing device or cloud service, such as computing device 2000. In a basic configuration, computing device 2000 may include at least one processing unit 2002 and a system memory 2004. Depending on the configuration and type of computing device, system memory 2004 may comprise, but is not limited to, volatile (e.g. random-access memory (RAM)), non-volatile (e.g. read-only memory (ROM)), flash memory, or any combination. System memory 2004 may include operating system 2005, one or more programming modules 2006, and may include a program data 2007. Operating system 2005, for example, may be suitable for controlling computing device 2000's operation. In one embodiment, programming modules 2006 may include image-processing module, machine learning module. Furthermore, embodiments of the disclosure may be practiced in conjunction with a graphics library, other operating systems, or any other application program and is not limited to any particular application or system. This basic configuration is illustrated in FIG. 20 by those components within a dashed line 2008.

Computing device 2000 may have additional features or functionality. For example, computing device 2000 may also include additional data storage devices (removable and/or non-removable) such as, for example, magnetic disks, optical disks, or tape. Such additional storage is illustrated in FIG. 20 by a removable storage 2009 and a non-removable storage 2010. Computer storage media may include volatile and non-volatile, removable and non-removable media implemented in any method or technology for storage of information, such as computer-readable instructions, data structures, program modules, or other data. System memory 2004, removable storage 2009, and non-removable storage 2010 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 2000. Any such computer storage media may be part of device 2000. Computing device 2000 may also have input device(s) 2012 such as a keyboard, a mouse, a pen, a sound input device, a touch input device, a location sensor, a camera, a biometric sensor, etc. Output device(s) 2014 such as a display, speakers, a printer, etc. may also be included. The aforementioned devices are examples and others may be used. Computing device 2000 may also contain a communication connection 2016 that may allow device 2000 to communicate with other computing devices 2018, such as over a network in a distributed computing environment, for example, an intranet or the Internet. Communication connection 2016 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2004, including operating system 2005. While executing on processing unit 2002, programming modules 2006 (e.g., application 2020 such as a media player) may perform processes including, for example, one or more stages of methods, algorithms, systems, applications, servers, databases as described above. The aforementioned process is an example, and processing unit 2002 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A method of facilitating inspection of industrial infrastructure by one or more industry experts, the method comprising:
receiving, using a communication device, inspection data from at least one monitoring device associated with an industrial infrastructure;
transmitting, using the communication device, the inspection data to a plurality of user devices associated with a plurality of industry experts;
receiving, using the communication device, annotation data corresponding to the inspection data from the plurality of user devices;
storing, using a storage device, the annotation data in association with the inspection data;
analyzing, using a processing device, the annotation data;
generating, using the processing device, an inspection report based on the analyzing; and
storing, using the storage device, the inspection report.

2. The method of claim 1, wherein the industrial infrastructure comprises electrical infrastructure.

3. The method of claim 1, wherein the at least one monitoring device comprises a drone configured for sensing the inspection data.

4. The method of claim 1, wherein the inspection data comprises at least one of audio, image and video.

5. The method of claim 1, wherein the receiving of the annotation data comprises receiving annotated inspection data comprising the inspection data and the annotation data, wherein the generating of the inspection report is based further on analyzing of the inspection data corresponding to the annotation data.

6. The method of claim 1 further comprising:
analyzing, using the processing device, the inspection data;
retrieving, using the storage device, a plurality of user profiles associated with the plurality of industry experts;
determining, using the processing device, the plurality of user devices based on the analyzing of the inspection data and the plurality of user profiles.

7. The method of claim 6, wherein the analyzing of the inspection data comprises performing object recognition of at least one object associated with the industrial infrastructure as represented in the inspection data.

8. The method of claim 1, wherein the annotation data comprises inspection advisories.

9. The method of claim 8 further comprising:
analyzing, using the processing device, the inspection data and the inspection advisories;
identifying, using the processing device, at least one discrepancy associated with the inspection advisories based on the analyzing of the inspection data and the inspection advisories; and
modifying, using the processing device, the inspection advisories based on the identifying of the at least one discrepancy.

10. The method of claim 9, wherein the analyzing of the inspection data and the inspection advisories comprises:
determining at least one characteristic of at least one object associated with the industrial infrastructure as represented in the inspection data; and
comparing the at least one characteristic with the inspection advisories corresponding to the at least one object, wherein the identifying of the at least one discrepancy is based on the comparing.

11. A system for facilitating inspection of industrial infrastructure by one or more industry experts, the system comprising:
a communication device configured for:
receiving inspection data from at least one monitoring device associated with an industrial infrastructure;
transmitting the inspection data to a plurality of user devices associated with a plurality of industry experts; and
receiving annotation data corresponding to the inspection data from the plurality of user devices;
a processing device configured for:
analyzing the annotation data;
generating an inspection report based on the analyzing; and
a storage device configured for:
storing the annotation data in association with the inspection data; and
storing the inspection report.

12. The system of claim 11, wherein the industrial infrastructure comprises electrical infrastructure.

13. The system of claim 11, wherein the at least one monitoring device comprises a drone configured for sensing the inspection data.

14. The system of claim 11, wherein the inspection data comprises at least one of audio, image and video.

15. The system of claim 11, wherein the receiving of the annotation data comprises receiving annotated inspection data comprising the inspection data and the annotation data, wherein the generating of the inspection report is based further on analyzing of the inspection data corresponding to the annotation data.

16. The system of claim 11, wherein the processing device is further configured for:
analyzing the inspection data; and
determining the plurality of user devices based on the analyzing of the inspection data and a plurality of user profiles, wherein the storage device is further configured for retrieving the plurality of user profiles associated with the plurality of industry experts.

17. The system of claim 16, wherein the analyzing of the inspection data comprises performing object recognition of at least one object associated with the industrial infrastructure as represented in the inspection data.

18. The system of claim 11, wherein the annotation data comprises inspection advisories.

19. The system of claim 18, wherein the processing device is further configured for:
analyzing the inspection data and the inspection advisories;
identifying at least one discrepancy associated with the inspection advisories based on the analyzing of the inspection data and the inspection advisories; and
modifying the inspection advisories based on the identifying of the at least one discrepancy.

20. The system of claim 19, wherein the analyzing of the inspection data and the inspection advisories comprises:
determining at least one characteristic of at least one object associated with the industrial infrastructure as represented in the inspection data; and
comparing the at least one characteristic with the inspection advisories corresponding to the at least one object, wherein the identifying of the at least one discrepancy is based on the comparing.
